(19) United States
(12) Patent Application Publication
(10) Pub. No.: US 2017/0152131 A1
(43) Pub. Date: Jun. 1, 2017

(54) Reusable Siphon Head for Standard Beverage Bottles

(71) Applicant: JEZEKIEL BEN-ARIE, CARLSBAD, CA (US)

(72) Inventor: JEZEKIEL BEN-ARIE, CARLSBAD, CA (US)

(21) Appl. No.: 15/359,628

(22) Filed: Nov. 23, 2016

Related U.S. Application Data
(60) Provisional application No. 62/260,267, filed on Nov. 26, 2015.

(51) Int. Cl. B67D 1/04; B65D 83/48; B65D 83/20; B67D 1/00; B67D 1/14

(52) U.S. Cl. CPC B67D 1/0456; B67D 1/0004; B67D 1/0082; B67D 1/1455; B65D 83/20; B65D 83/48

(57) ABSTRACT

A reusable Siphon Head which has a helical threaded opening that allows to install it on standard beverage bottles. The Siphon Head enables to dispense carbonated beverages multiple times from the same beverage bottle with minimal loss of gas pressure. The Siphon Head has a screw based valve which enables to achieve gradual and smooth control of beverage outflow and also to apply high blocking pressure with only small manual effort. The Siphon head has a simple structure with minimal number of parts which is suitable for inexpensive plastics mass production and assembly. The Siphon Head does not have any metallic parts. The high pressure blocking allows for long term beverage storage with minimal pressure loss.

### CROSS-REFERENCE TO RELATED APPLICATIONS

The present application claims priority from a provisional patent application: Ser. No. 62/260,267 filed on Nov. 26, 2015

### FEDERALLY SPONSORED RESEARCH

Not Applicable.

### SEQUENCE LISTING OR PROGRAM

Not Applicable.

### TECHNICAL FIELD

The present invention relates to installable siphon heads for standard beverage bottles.

### BACKGROUND ART

The basic technique of beverage siphon head bottles is well known in the prior art. The siphon's dispensing head is attached to a bottle which contains pressurized carbonated beverage. The siphon head has a control valve, a vertical pipe that descends to the bottom of the bottle and a dispensing nozzle. When the user opens the valve the beverage is forced out via the vertical pipe and the nozzle by the pressurized gas in the bottle. Siphon head bottles were manufactured and sold in large quantities in the past. However, they were sold as an attached siphon head and bottle units and already contained soda water. These bottles were made of reinforced glass and were returned to the seller after they were emptied and were refilled by the seller. Another kind of siphon head bottle is disclosed by Hinz in U.S. Pat. No. 3,324,903. Hinz's siphon head has a removable siphon head and could be refilled with tap water. The pressurized gas was then added by temporarily attaching the siphon head to a canister of pressurized gas. Siphon head bottles were also disclosed by Fassmann in U.S. Pat. No. 710,674, by Pletman in U.S. Pat. No. 3,372,392, by Roberts in U.S. Pat. No. 2,539,929, by Caitung in U.S. Pat. No. 2,678,947, by Aicart in U.S. Pat. No. 2,830,745, by Jurasek in U.S. Pat. No. 3,317,092, by Hinz in U.S. Pat. No. 3,324,903, by Hoffman in U.S. Pat. No. 3,351,415, by Kleveland in U.S. Pat. No. 3,415,426, by Hagan et al. in U.S. Pat. No. 4,617,973, by Hagan in U.S. Pat. No. 4,660,748, by Hagan in U.S. Pat. No. 4,671,436 and in U.S. Pat. No. 4,694,975, by Hagan et al. in U.S. Pat. No. 4,773,571, by Nagy in U.S. Pat. No. 4,860,932, by Hagan et al. in U.S. Pat. No. 5,046,645, by Sanders et al. in U.S. Pat. No. 5,588,562 and by Bargo in U.S. Pat. No. 8,328,053. Siphon heads were also disclosed in patent applications by Colan et al. in US 2005/0236439, and by Lindmayer in US 2006/0266773.

All these inventions disclose siphon heads with pipes immersed in pressurized carbonated beverages. At the ends of these pipes these siphon heads have valves which block the beverage outflow with blocking members which are pressed against the pipes' openings by resilient forces of springs or membranes. These valves are switched from a closed state to an opened state by overcoming the resilient forces and mechanically moving the blocking members away from the openings and creating gaps which allow the beverages to flow out from the openings. The blocking members are forced to move to open states by users' applied manual pressures which overcome the resilient bias forces of the springs or the membranes. Applying such manual pressures require complex mechanical structures which include levers, arms and other mechanical components. As a result, the mechanical structures of these siphon heads is mostly metallic, complex and require expensive manufacturing. The upshot is that these siphon heads are not suitable for inexpensive plastic mass production and are too expensive for installment on standard beverage bottles.

### BRIEF DESCRIPTION OF THE INVENTION

Currently, beverage bottles with carbonated beverages are sold with a simple screwed cap. The beverages contain pressurized carbon dioxide gas and the cap is screwed tightly to prevent the gas from escaping. However, when someone unscrews the cap in order to pour a drink, a significant amount of the pressurized gas escapes and when the bottle is recapped much of the gas pressure is lost. Beverage bottles are usually uncapped and recapped several times before they are emptied. But frequently the beverage loose almost all of the pressurized gas if the bottle was opened too many times and the beverage becomes stale. Recently, a company named Soda Stream developed a device which also fills bottles of tap water with pressurized gas supplied by a pressurized gas canister. The problem with their approach is the same as the problem of regular beverage bottles because they do not have a siphon head and therefore their soda water loose gas pressure whenever their bottles are opened.

First objective of our approach is to develop a reusable siphon head which can be installed on standard beverage bottles. The user just replaces the bottle's cap with our siphon head and then can pour the beverage while having only a relatively small amount of gas pressure lost in each use. The beverage remains pressurized and bubbly till the last drop. Our siphon head can then be reused many times by removing it from the emptied bottle and re-installing it on a new bottle. This process can be repeated and our siphon head can be reused many times. We do not attempt to provide pressurized gas with our siphon head. We utilize the pressurized gas that is already stored in each beverage bottle sold.

Second objective of our invention is to design installable siphon heads which have simple mechanical structure, which is suitable for inexpensive mass production manufacturing from plastics.

Third objective of our invention is to design installable siphon heads which have simple yet effective mechanical structure with minimal number of parts that are easy and inexpensive to assemble when manufactured.

Fourth objective of our invention is to design installable siphon heads which have pure plastics structure, which do not need metallic parts such as springs or membranes.

Fifth objective of our invention is to design installable siphon heads which have simple plastics structures but have valves with outflow blocking pressures that are much higher than conventional spring based valves. Thus, our installable siphon heads enable long term storage of carbonated beverage bottles without loss of gas pressure.

Sixth objective of our invention is to design installable siphon heads which have simple plastics structure that have valves which enable a smooth gradual opening and allow the user to easily and smoothly control the strength of beverage outflow stream. In comparison, valves in conventional siphon heads do not allow smooth outflow control because they have only sharp transitions between fully open and fully closed states.

Seventh objective of our invention is to design installable siphon heads which have simple plastics structure that have valves which do not need high manual forces to operate in comparison to conventional siphon heads which require relatively high manual forces to overcome their resilient springs' biases.

According to our objectives, our installable siphon head has a helical threaded opening which enables one to install it on standard beverage bottles. At the center of the helical threaded opening there is an attached pipe which descends vertically into the beverage bottle. The upper opening of the pipe is connected to a conical control opening (other kinds of control openings are also described) which opens its wider side up into the hollow chamber of the siphon head. The hollow chamber is connected also to a dispensing nozzle which is directed diagonally down. On top side of the siphon head there is a screw threaded opening into the hollow chamber. The screw threaded opening is exactly aligned opposite to the center of the conical control opening below. A screw screwed into the screw opening lands exactly at the center of the conical control opening. A conical plug pointing downwards which fits the conical control opening, is installed at the bottom side of the screw. The conical plug is made of elastic plastic material and is rotatably connected to a hollow cavity at the center of the bottom side of the screw. When one screws the screw downwards the conical plug presses onto the conical control opening and blocks any beverage outflow. The rotatable connection of the conical plug to the screw enables one to continue turning the screw even if the plug is already pressing the conical control opening, thus increasing the blocking pressure even further. Due to the leveraged operation of the screw one can apply very high blocking pressure of the plug on the conical control opening without much effort. This endows the siphon head valve with very efficient blocking of pressurized beverage, which allows long term beverage storage without pressure loss. In addition, one can smoothly control the beverage outflow by gradually releasing the blocking pressure of the plug on the conical control opening. On the upper side of the screw there is an attached rotating member which facilitates the manual turning of the screw by the user. The rotating member could assume the shape of a flat bar, a shape of a disk or any other shape which facilitates manual turning of the screw.

As can be observed from the drawings, our siphon head has simple plastics structure, which is designed to be wholly manufactured from plastic material and its structure is simplified such that it includes minimal number of parts (i.e. an installable siphon head main structure, a manual screw, a conical plug, a washer and a vertical pipe) and could be assembled very easily. For this reason, our installable siphon head introduces a simple yet efficient valve which utilizes a screwing mechanism to fasten a conical plug onto a conical control opening. This principle of operation is entirely different from other siphon head valves which rely on moving a blocking member which controls the flow by opening and closing a gap between the blocking member and a beverage pipe opening. Moving blocking members are incapable of exerting high pressure on the beverage openings they control because their moving mechanisms rely on springs or membranes to provide resilient pressing forces for their blocking members. One cannot use higher pressure springs or membranes because the amount of pressure the user has to apply in order to open the valve against the spring's bias is limited. In contrast, the amount of pressure that a screwing plug provides manually is much higher due to the leveraged mechanical operation of the screw, which does not need high manual effort from the user. As a result, screw based valves can apply much higher blocking pressure and therefore have much better blocking of pressurized liquids compared to conventional valves. This high blocking pressure is not hard to achieve manually by the user with a screw based valve since the screw has a leveraged operation which multiplies and converts the user's manually manufactured turning moment of the screw into a linear pressure of the screw's conical plug on the conical control opening. Thus, our installable siphon heads enable long term storage of carbonated beverage bottles without significant loss of gas pressure. Additional advantage of the screw based valve is its capability for smooth control of the beverage outflow stream by gradually opening and closing of the valve's screw. In comparison, valves in conventional siphon heads do not allow smooth beverage outflow control because they have only sharp transitions between fully open and fully closed states.

In conclusion, our installable siphon head has simple plastics structure, which is designed to be inexpensively manufactured from plastic material and its structure was simplified such that it includes minimal number of parts (i.e. an installable head structure, a manual screw, a conical plug, a washer and a vertical pipe) and could be assembled very easily. For this reason, our installable siphon head introduces a simple yet efficient valve which utilizes a screwing mechanism to fasten a conical plug onto a conical control opening. This principle of operation is entirely different from other siphon head valves which rely on a moving blocking member which controls the flow by opening and closing a gap between the blocking member and a beverage pipe opening. Moving blocking members are incapable of exerting high pressure on the beverage openings they control because their moving mechanisms rely on springs or membranes to provide resilient pressing forces for their blocking members. One cannot use higher pressure springs or membranes because the amount of pressure the user has to apply in order to open the valve against the spring's bias is limited. In contrast, the amount of pressure that a screwing plug provides manually is much higher due to the leveraged mechanical operation of the screw, which does not need high manual effort from the user. As a result, screw based valves can apply much higher blocking pressure and therefore have much better blocking of pressurized liquids compared to spring operated valves. This high blocking pressure is not hard to achieve manually by the user with a screw based valve since the screw has a leveraged operation which multiplies and converts the user's manually manufactured turning moment of the screw into a linear pressure of the screw's plug on the plug's opening. Thus, our installable siphon heads enable long term storage of carbonated beverage bottles without loss of gas pressure. Additional advantage of the screw based valve is its capability for smooth control of the beverage outflow stream by gradually opening and closing of the valve's screw. In comparison, valves in conventional siphon heads do not allow smooth beverage outflow control because they have only sharp transitions between fully open and fully closed states.

We propose two additional alternatives for the shape of the plug and the control opening. One alternative is to use a plug with planar bottom and control opening with a shape of a planar ring. A second alternative is to use a plug with convex shape and a control opening with matching concave shape. These alternatives are suggested in addition to the convex conical shape of the plug and matching concave conical shape of the control opening.

### BRIEF DESCRIPTION OF THE DRAWINGS

FIG. 1 illustrates a 3D isometric drawing of an embodiment of our screw based siphon head which is installed on a beverage bottle.

FIG. 2 describes a cross section side view an embodiment of our screw based siphon head which is installed on a beverage bottle. FIG. 2 illustrates an alternative embodiment of siphon head with convex conical shape of the plug and matching concave conical shape of the control opening.

FIG. 3 describes a cross section side view an embodiment of our screw based siphon head which is installed on a beverage bottle. FIG. 3 illustrates an alternative embodiment of siphon head with a plug with planar bottom and control opening with a shape of a planar ring.

FIG. 4 describes a cross section side view an embodiment of our screw based siphon head which is installed on a beverage bottle. FIG. 4 illustrates an alternative embodiment of siphon head with convex shape of the plug and matching concave shape of the control opening.

### DETAILED DESCRIPTION OF THE DRAWINGS

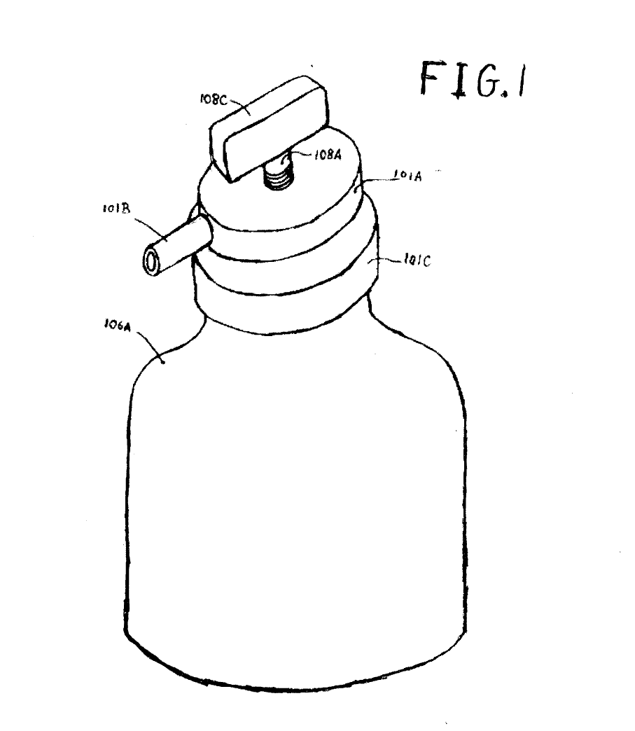

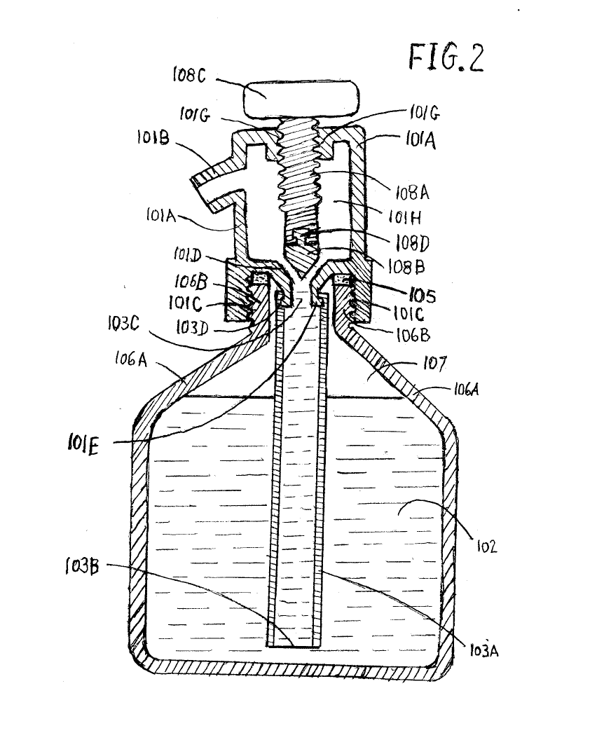

FIG. 1 depicts a 3D isometric drawing of an embodiment of our screw based siphon head 101A which is installed on a beverage bottle 106A. The siphon head's main structure 101A has a screw 108A pushing a plug 108B (shown in FIG. 2) which is used to block the flow in the siphon head's valve. The screw 108A has a rotating member 108C which is used as a handle which facilitates manual rotation of the screw 108A. The rotating member 108C which is depicted in FIGS. 1, 2, 3, 4 has the shape of a flat bar. However, the rotating member 108C could assume the shape of a disc or any other shape which facilitates manual turning of the screw 108A. The siphon head's main structure 101A has a dispensing nozzle 101B which conducts the outflow of the beverage when the siphon head's valve is open.

FIG. 2 illustrates a cross section side view an embodiment of our screw based siphon head which is installed on a beverage bottle 106A. The siphon head's main structure 101A includes a dispensing nozzle 101B, a conical control opening 101D, a helical screw threading 101G, which fits the threading of the screw 108A, a cylindrical opening with helical threading 101C, which fits helical threading of standard beverage bottle openings 106B and a flange 101E, which is used to attach the pipe 103A to the siphon head's main structure 101A using the annular groove 103C. The siphon head's main structure 101A has a chamber 101H and also has a screw 108A pushing a conical plug 108B which is used to block the outflow from the conical control opening 101D. The conical plug 108B and the conical control opening 101D form the siphon head's valve. The screw 108A has a rotating member 108C which facilitates manual turning of the screw 108A. The siphon head's main structure 101A has a dispensing nozzle 101B which conducts the outflow of the beverage diagonally down when the siphon head's valve is open. A helical threaded cylindrical opening 101C is designed for fastening the main structure of the siphon head 101A to the bottle 106A using fitting threaded bottle opening 106B. The helical threaded cylindrical opening 101C fits the helical threaded cylindrical opening 106B (a threaded pipe opening) of standard beverage bottles and allows fastening the main structure of the siphon head 101A to the helical threaded cylindrical openings of standard beverage bottles, thus sealing the bottle and blocking outflows of gas or beverage. Improved sealing of the siphon head 101A to the bottle 106A is facilitated by the washer 105 which is made of flexible and resilient material. The screw 108A can be turned by the user using a rotating member 108C, which is attached to the upper end of the screw 108A. The conical plug 108B which is made of resilient material, is rotatably connected to the lower end of the screw 108A by a flexible nail head 108D, thus enabling the screw to rotate further even when the conical plug 108B is already touching the conical control opening 101D. Further screw rotation increases the outflow blocking pressure of the conical plug 108B on the conical control opening 101D. The bottle has pressurized beverage fluid 102 under pressurized gas 107. The conical plug 108B which is fitted into a conical control opening 101D form a valve. At the closed position of the valve, the conical plug 108B is pressed against the conical control opening 101D and blocks the outflows of beverage 102 which is pushed by the pressurized gas 107 via the pipe 103A and the pipe's openings 103B and 103C. The conical plug 108B is held at a closed position by a helical threading screw 108A which is screwed through the helical threaded opening 101G in the siphon head's main structure 101A. The screw 108A is designed to push the conical plug 108B downwards and to block the conical control opening 101D when the valve is in closed position. When the user wants to pour some beverage, the user unscrews the screw 108A by turning the rotating member 108C this raises the conical plug 108B and releases the pressure on the conical control opening 101D and the beverage 102 which is pushed by the pressurized gas 107 flows outside via the pipe 103A and via the bottom opening 103C and through the conical control opening 101D into the chamber 101H which feeds the dispensing nozzle 101B. The pipe 103A is attached to the siphon head's main structure 101A by an annular groove 103D, which fits the round flange 101E. The pipe 103A descends from the bottom opening 103C all the way to the inner bottom of the beverage bottle 106A (except for a small gap) thus enabling to empty most of the beverage from the bottle since the pressurized gas 107 pushes the beverage 102 upwards through the pipe 103A openings 103B and 103C, through the conical control opening 101D and through the chamber 101H which feeds the dispensing nozzle 101B

The assembly of the siphon head is quite simple. First the conical plug 108B is installed at the bottom of the screw 108A by pushing the resilient nail head 108D into the fitting cavity at the bottom of the screw 108A. Next, the screw 108A is screwed into the siphon head's main structure 101A via the screw threading 101G. Notice that the plug 108B has narrower diameter than the inner diameter of the screw threading 101G to allow it to pass through the threading 101G. Finally, the pipe 103A is attached to the siphon head's main structure 101A by installing the pipe's annular groove 103C onto the round flange 101E.

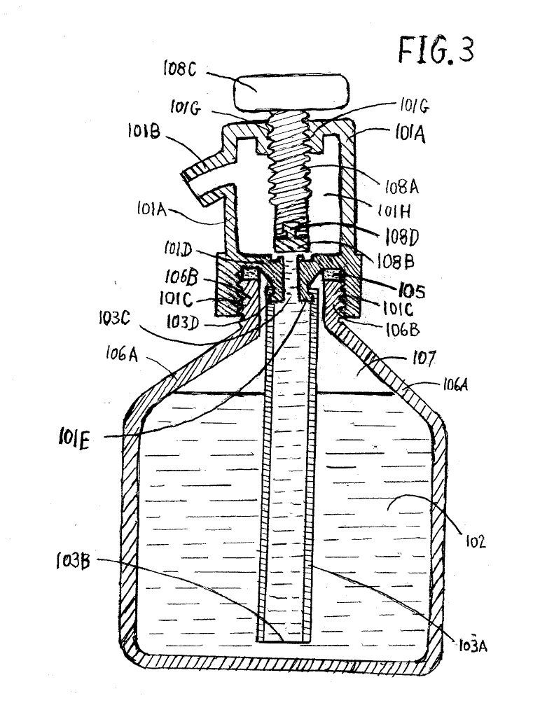

FIG. 3 describes a cross section side view an embodiment of our screw based siphon head which is installed on a beverage bottle. FIG. 3 illustrates an alternative embodiment of siphon head with a plug 108B with planar bottom and control opening 101D with a shape of a planar ring. Except for the change in the plug 108B and the control opening 101D shapes, FIG. 3 describes the same siphon head as in FIG. 2.

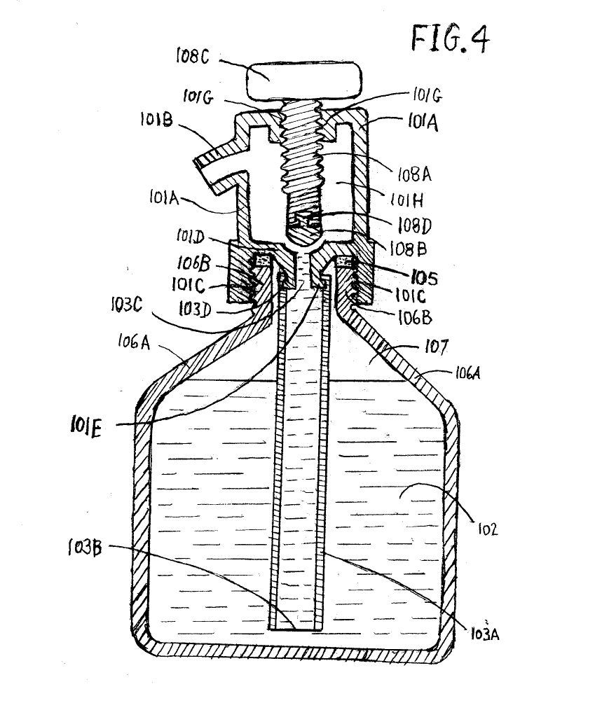

FIG. 4 describes a cross section side view an embodiment of our screw based siphon head which is installed on a beverage bottle. FIG. 4 illustrates an alternative embodiment of siphon head with convex shape of the plug 108B and matching concave shape of the control opening 101D. Except for the change in the plug 108B and the control opening 101D shapes, FIG. 4 describes the same siphon head as in FIG. 2.

What is claimed is:

1. A siphon head for dispensing beverages, which can be installed on standard beverage bottles;
wherein said siphon head comprising: a main structure, a screw, a rotating member, a plug, a pipe and a washer;
wherein said plug and said washer are made of elastic material;
wherein, said main structure comprising: a cylindrical opening, a control opening, a bottom opening, a screw opening, a chamber, and a dispensing nozzle;
wherein said main structure has at its top side a structure top side; wherein said main structure has at its bottom side a structure bottom side;
wherein said cylindrical opening has an inner helical thread; wherein said cylindrical opening is installed at said structure bottom side;
wherein said control opening has at its upper side a control opening upper side; wherein said control opening has at its lower side a control opening lower side; wherein said control opening lower side is connected to said bottom opening;
wherein said chamber is hollow; wherein said chamber is connected to said control opening via said control opening upper side;
wherein said dispensing nozzle is connected to said chamber;
wherein said bottom opening has at its lower end a bottom opening lower end; wherein said bottom opening lower end has a round flange;
wherein said pipe has at its upper end a pipe upper end; wherein said pipe has at its lower end a pipe lower end; wherein said pipe has an inner annular groove at said pipe upper end;
wherein said pipe is vertically attached to said bottom opening lower end at said pipe upper end by inserting said round flange into said inner annular groove;
wherein said inner helical thread fits an outer helical thread of a standard opening of said standard beverage bottles; wherein said washer improves sealing of fastened said inner helical thread to said outer helical thread of said standard beverage bottles and prevents gas leakage;
wherein said main structure has said screw opening at said structure top side; said screw opening has a screw threading which fits said screw; wherein when said screw is screwed downwards via said screw opening, said screw is directed towards the center of said control opening upper side;
wherein said plug has at its upper side a plug upper side; wherein said plug has at its lower side a plug lower side;
wherein said screw has at its top side a screw top side; wherein said screw has at its bottom side a screw bottom side; wherein said plug upper side is attached to said screw bottom side;
wherein said plug and said control opening form a valve which controls outflow of beverage via said control opening; wherein said valve is in a closed position when said plug is pressed against said control opening and blocks any outflow of beverage via said control opening; wherein said valve is in an opened position when said plug is not pressed against said control opening and allows said outflow of beverage via said control opening;
whereby, a user can achieve smooth control of the amount of said outflow of beverage from said standard beverage bottle by turning said screw and thereby controlling the pressure of said plug on said control opening;
wherein said screw top side is connected to a rotating member which facilitates manual turning of said screw;
whereby, when said valve is in said opened position, the gas pressure in said standard beverage bottle pushes the beverage via said pipe through said bottom opening and via control opening into said chamber; from said chamber the beverage flows outside via said dispensing nozzle.

2. The siphon head of claim number 1, wherein said plug upper side has a planar top; said planar top has a center top at the center of said planar top; wherein a resilient nail head is attached to said planar top at said center top; wherein said screw bottom side is also planar but has a nail head cavity which fits said resilient nail head;
wherein said plug is rotatably attached to said screw bottom side by inserting said resilient nail head into said nail head cavity;
whereby, said screw can further turn and further increase said plug's pressure on said control opening even when said plug is already pressed onto said control opening;
thereby, increasing said plug's pressure on said control opening improves sealing of said control opening and prevents loss of said gas pressure during storage.

3. The siphon head of claim number 1, wherein said plug has a shape of a convex cone; wherein the tip of said shape of a convex cone points downwards; wherein said control opening has a shape of a concave cone, which fits the shape and the orientation of said shape of a convex cone;
whereby, fitting shapes of said plug and said control opening improve sealing of said valve when said valve is in said closed position.

4. The siphon head of claim number 1, wherein said plug lower side has a planar shape; wherein said control opening upper side has a shape of a planar ring;
whereby, when said plug is pressed against said control opening upper side said planar ring sinks into said elastic material of said plug and improves sealing of said valve when said valve is in said closed position.

5. The siphon head of claim number 1, wherein said plug has a convex shape: wherein said control opening has a concave shape which fits the shape and the orientation of said convex shape;
whereby, fitting shapes of said plug and said control opening improve sealing of said valve when said valve is in said closed position.

6. The siphon head of claim number 1, wherein said standard beverage bottle has at its inside bottom an inside bottom; wherein when said siphon head is installed on said standard beverage bottle, said pipe lower end descends downwards; wherein said pipe lower end has a predetermined gap above said inside bottom;
whereby, said gap enables emptying said standard beverage bottles up to said predetermined gap level.

7. The siphon head of claim number 1, wherein said rotating member has a shape of a flat bar which facilitates manual turning.

8. The siphon head of claim number 1, wherein said rotating member has a shape of a disc which facilitates manual turning.
